(19) United States
(12) Patent Application Publication
(10) Pub. No.: US 2006/0069560 A1
(43) Pub. Date: Mar. 30, 2006

(54) Method and apparatus for controlling recognition results for speech recognition applications

(76) Inventors: Christopher Passaretti, Smithtown, NY (US); Chingfa Wu, Nesconset, NY (US)

Correspondence Address: Brian P. Hopkins, Esq.;Mintz, Levin, Cohn, Ferris, Glovsky and Popeo, P.C, The Chrysler Center, 666 Third Avenue, 24th Floor, New York, NY, 10017, US

(21) Appl. No.: 10/930,156

(22) Filed: Aug. 31, 2004

(51) Int. Cl. G10L 15/00; G10L 15/06; G10L 19/14; G10L 15/04

(52) U.S. Cl. 704/251; 704/231; 704/234; 704/244

(57) ABSTRACT

A diagnostic tool for speech recognition applications is provided, which enables a person to edit results achieved by a speech recognizer, during runtime, to determine results of various inputs. The results that can be altered are the speech recognition result, the confidence levels of the output, the N-Best list and the interpretation of the input speech. The invention allows the path taken by the application based on these new results to be observed. The invention enables the capabilities of the speech recognition application to be thoroughly tested without requiring multiple calls to the application.

### FIELD OF THE INVENTION

The present invention relates generally to speech recognition software and more particularly to a diagnostic tool that allows editing results achieved by a speech recognizer, during runtime, in a speech recognition system, without the need for multiple different sessions by the operator.

### BACKGROUND OF THE INVENTION

A speech recognition system typically includes an input device, a voice board that provides analog-to-digital conversion of a speech signal, and a signal processing module that takes the digitized samples and converts them into a series of patterns. These patterns are then compared to a set of stored models that have been constructed from the knowledge of acoustics, language, and dictionaries. The technology may be speaker dependent (trained), speaker adaptive (improves with use), or fully speaker independent. In addition, features such as “barge-in” capability, which allows the user to speak at anytime, and key word spotting, which makes it possible to pick out key words from among a sentence of extraneous words, enable the development of more advanced applications.

A grammar processor is a device that accepts grammars as input. Grammars are the words, rules or phrases that will be detected in the application. A user agent is a grammar processor that accepts user input and matches that input against a grammar to produce a recognition result that represents the detected input. The type of input accepted by a user agent is determined by the mode or modes of grammars it can process (e.g. speech input for “voice” mode grammars and DTMF input for “dtmf” mode grammars.)

Speech recognizers may be considered a sophisticated class of grammar processor. A speech recognizer is a user agent with the following inputs and outputs:
Input: A grammar or multiple grammars which inform the recognizer of the words and patterns of words to detect. An audio stream that may contain speech content that matches the grammar(s).
Output: Results that indicate details about the speech content detected by the speech recognizer. Most conventional recognizers will provide at least a transcription of any detected words.

The primary use of grammar, specific to a speech recognized, is to permit a voice recognition application to indicate to a recognizer what words it should detect, specifically: words that may be spoken, patterns in which those words may occur, and language of each word.

Speech recognizers report a degree of confidence level—that is, the likelihood of having correctly recognized a word or phrase—and may provide the most likely alternatives when the recognizer is uncertain as to which word the user actually said.

Confidence measures (CMs) are defined as probabilities of correctness of a statistical result. CMs for speech recognition are used to make speech recognition usable in real life applications. CMs provide a test statistic for accepting or rejecting the recognition hypothesis of the speech/speaker recognition system.

CMs provide the confidence level that a speech recognition module has in every generated result. Computing the Likelihood Ratio (LR) of the scores of first best and some alternative result gives information about the probability that a certain recognition is correct. CMs can be used for different purposes during or after the speech recognition process.

The main goal of speech recognition applications is to mimic human listeners. When a human listener hears a word sequence, he/she automatically attributes a confidence level to the utterance; for example, when the noise level is high, the probability of confusion is high and a human listener will probably ask for a repeat of the utterance. Accordingly, the confidence level is used to make further decisions on a recognized sequence. The “confidence level” obtained from the confidence measure is then used for various validations of the speech recognition results.

Semantic Interpretation. A speech recognizer may be capable of matching audio input against a grammar to produce a raw text transcription (also known as literal text) of the detected input. A recognizer may also be capable of performing subsequent processing of the raw text to produce a semantic interpretation of the input.

For example, a user says “Transfer 100 dollars from checking to savings” or “Transfer 100 dollars to savings from checking.” Both of these sentences have the same meaning. To perform this additional interpretation step requires semantic processing instructions that may be contained within a grammar that defines the legal spoken input or in an associated document.

The true challenge in speech recognition systems is the recognition of errors—one can never be completely sure that the recognizer has made a correct interpretation of the input. Interacting with a recognizer over the telephone is like conversing with a foreign student learning a new language. Specifically, since it is easy for the conversational counterpart to misunderstand, one must continually check and verify, often repeating or rephrasing until the speaker is understood.

Not only can recognition errors be frustrating, but so can inconsistent responses. It is common for a user to say something once and have it recognized, then say it again and have it recognized incorrectly. This unpredictability makes it difficult for the user to construct and maintain a useful conceptual model of the applications' behaviors. When the user speaks and the computer performs the correct action, the user makes certain assumptions about cause and effect. When the user speaks the same thing again and a different action occurs due to a misrecognition, all of the assumptions are now called into question.

To thoroughly test the capabilities of a speech recognition application, conventional methods require a technician or programmer to call in multiple times to enable the speech recognizer to generate different results with different confidence levels. This method makes it very difficult to recreate scenarios and very time consuming.

Accordingly there exists a need for a diagnostic tool which enables one or more aspects of a result of a speech recognition application to be changed during run time.

### BRIEF SUMMARY OF THE INVENTION

The present invention provides an apparatus and a method for changing a result and/or an attribute of the result (collectively “an attribute”) and rerun a portion of the application using the changed information. The invention provides the ability to determine the path taken by the application based on the results from various inputs without the technician having to call into the system multiple times.

Accordingly, one aspect of the invention provides a method that includes receiving spoken input and determining a recognition result from the input. The recognition result includes a plurality of attributes. An attribute is then altered and the application is run with the altered attribute.

Another aspect of the invention provides a method that includes receiving spoken input and determining a recognition result of the input. The recognition result includes multiple attributes and a plurality of the multiple attributes are then altered and the application is run with the altered attributes.

Still another aspect of the invention provides a speech recognition diagnostic tool which includes a module for receiving spoken input and a module, in communication with the input module, for determining a recognition result. The recognition result includes a plurality of attributes. The diagnostic tool further includes a module, in communication with the determination module, for altering at least one of the plurality of attributes and a module for compiling and running the application with the altered attribute.

### BRIEF DESCRIPTION OF THE DRAWINGS

The invention will be described in more detail below with the reference to an embodiment to which, however, the invention is not limited.

FIG. 1 illustrates a sample application processing speech input.

FIG. 2 illustrates an embodiment of the present invention using the WVAD Suite implementation.

FIG. 3 illustrates WVAD message processing for Received Result.

FIG. 4 is block diagram of exemplary system for operating one or more applications for a speech diagnostic tool and/or speech diagnostic system according to embodiment of the present invention.

### DETAILED DESCRIPTION OF THE DRAWINGS

Conventional speech recognition applications allow a user to speak and the application attempts to determine the actual syntax and its actual meaning (interpretation). The application then performs a task based on a detection of the spoken utterance, confidence levels and interpretation.

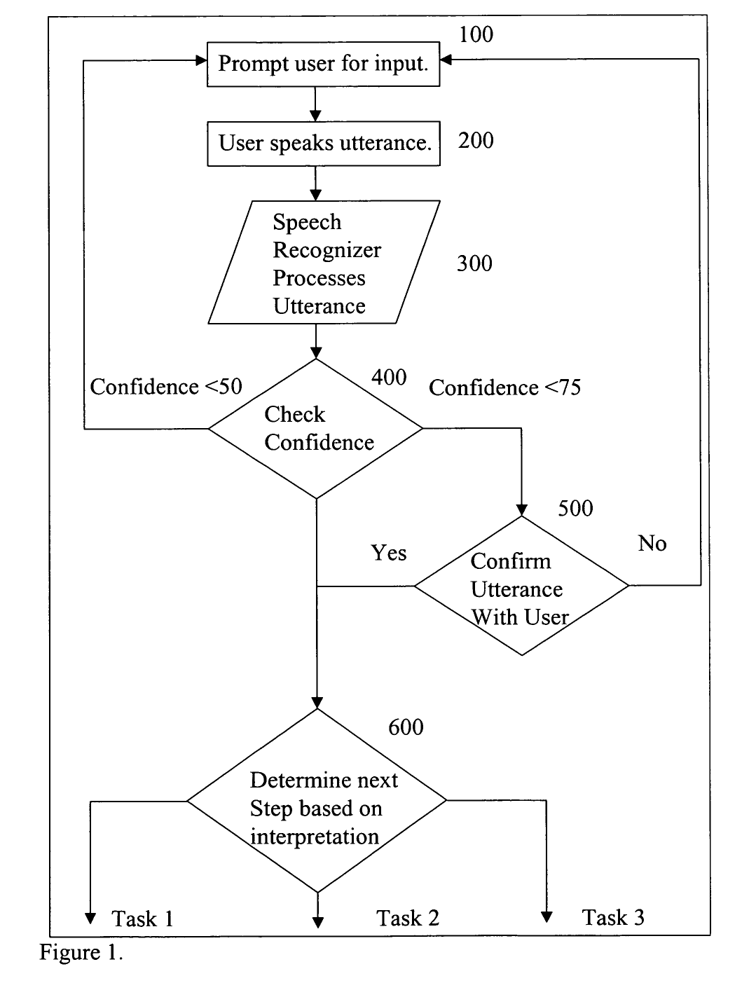

FIG. 1 provides a flow chart of a sample application processing speech input. As illustrated in Step 100, the application provides a prompt for input. The user then speaks (Step 200). The speech recognizer then processes the utterance and determines the spoken input and confidence level (Step 300). Subsequently, the application analyzes the confidence level of the spoken input (Step 400). In this example, if the confidence score is less than 50% then the input is rejected and the user is prompted again for input. If the confidence score is greater then 50% but less than 75%, the application asks the user to confirm the input (Step 500). If the confidence score is greater than 75%, or the user confirms the input having a confidence level greater then 50% and less than 75%, the application determines the next task based on the interpretation (Step 600). The numbers provided above are a mere design choice and could be higher or lower depending on a particular application.

As illustrated by this simple example, there are several paths that an application can take based on the determination of the input. In order to fully test this application, it should be determined how the application reacts to different inputs and different results. Currently, these applications are tested by placing multiple telephone calls to the application until the user gives up or determines that enough different utterances and confidence levels have been achieved. Alternatively drivers (or simulators) which use textual input (rather than a recognizer), are employed to insert all utterances and interpretations.

The present invention allows the use of the actual speech recognition output to drive the application and provides a method and apparatus which enables results achieved by a speech recognizer to be edited, during runtime, to determine results of various inputs.

According to an aspect of the invention, the results/attributes that can be altered are the speech recognition result, the confidence levels of the result, the N-Best list and the interpretation of the input speech. The N-Best list is a list of alternative recognitions/hypotheses in decreasing order of confidence. The following model provides an example of a N-Best list with corresponding confidence level for a telephone transaction during which a caller wants to buy tickets to a football game. The computer could prompt the caller “What is the name of the team you would like to purchase tickets for?” If the caller responds “NY Jets” the recognition result provided by the speech recognizer could be:

| N-BEST LIST | CONFIDENCE LEVEL |
|---|---|
| NY Jets | 90% |
| NY Mets | 80% |
| NJ Nets | 70% |
| NY Knicks | 50% |

During typical operation, the application would use the best result, the one with the highest confidence level, and take the appropriate action based on that result. Although it is possible that the program could be designed to select a different result. In this particular example the caller would be offered tickets for the NY Jets since the confidence level was 90%. The present invention allows the technician to change the N-best list and/or the confidence result to see how the program reacts. For example, if the technician changed the confidence level of NY Jets to 70% he would be able to observe the final outcome of this change (i.e. what happens in a application in the event of a tie between two confidence levels) and ultimately test the performance of the application.

An embodiment of the present invention allows the user to observe the path taken by the application based on these new results on a monitor such as a computer monitor. Although with the power of hand held devices such as PDAs, and wireless telephones increasing it is possible that this could be observed on a handheld device as well.

According to an embodiment of the invention a user provides spoken input. After the input is recognized, the application may be stopped. The user then has the ability to inspect and modify the speech recognition results, using a keypad, which include the utterance, confidence levels, n-best list, and interpretation.

The following is an example of a banking operation wherein a caller wants to transfer $100 from one account to another. The following 3 sentences have the same meaning (interpretation):
Transfer $100 from checking to savings.
Transfer $100 to savings from checking.
Withdraw $100 from savings and deposit $100 to checking.

The present invention allows the operator to stop the application after operating on one of these inputs (e.g. after inputting Transfer $100 from savings to checking), change to a different one of the inputs (e.g. Withdraw $100 from savings and deposit $100 to checking), and see how the application reacts.

While only a limited number of attributes have been discussed, there may be other attributes which an operator would wish to change. The ability to change these other attributes would fall within the scope of the present invention. According to another aspect of the invention this result can then be saved and potentially retrieved at another time for analysis or for reprocessing.

The invention will next be described as used in the main embodiment using a complete development, testing, and implementation environment called the Web-Centric Voice Applications Development Suite (WVAD Suite) produced by Nortel Networks Limited.

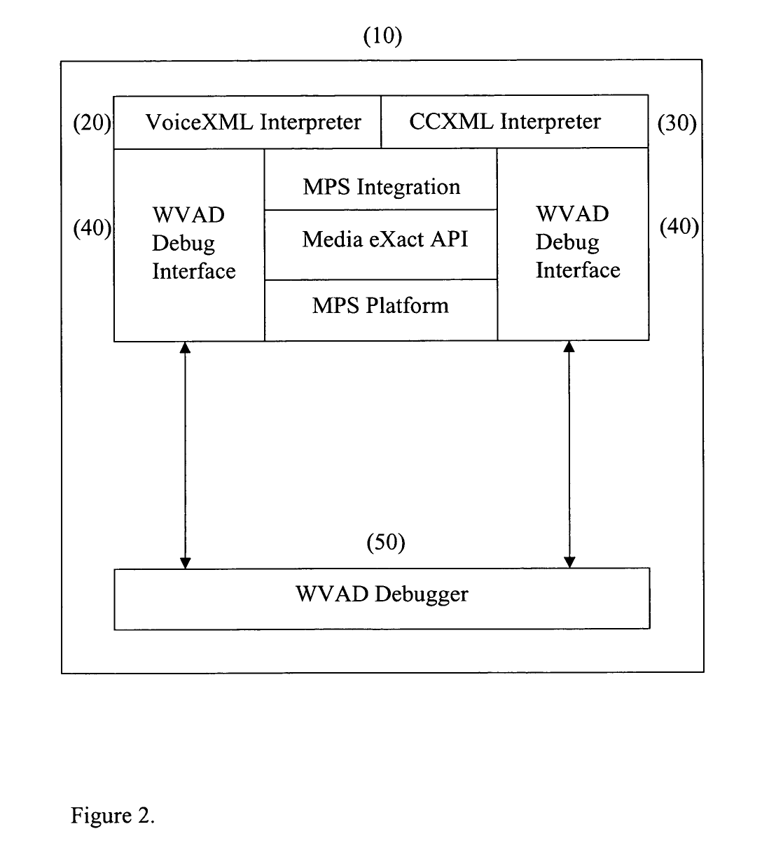

FIG. 2 provides a block diagram of the present invention. The WVAD Suite of tools (10) communicates with a Debug Interface (40) embedded in both a Voice eXtensible Markup Language (VoiceXML) (20) interpreter and a Call Control extensible Markup Language (CCXML) interpreter (30) as shown in FIG. 2. VoiceXML and CCXML are standards developed by the World Wide Web Consortium (W3C) as extensible markup language (XML) dialects for the creation of voice applications in a Web-based environment. The W3C develops interoperable technologies (specifications, guidelines, software, and tools) to lead the Web to its full potential. VoiceXML is a platform independent structured language created using the XML specification to deliver voice content through several different media like the web and phone system. VoiceXML enables Web-based applications to communicate with voice processing systems and to extend Interactive Voice Recognition (“IVR”) and advanced speech applications into a browser that gives users access to Web-based information via any voice-capable device, such as a telephone. CCXML is a software language which allows developers to program telephone switches and computer telephone devices. CCXML works with—and complements—Voice XML to offer greater call control. Applications using CCXML can seamlessly transfer calls, establish conference calls, or monitor incoming calls involving an “unplanned event” such as a request for specific information.

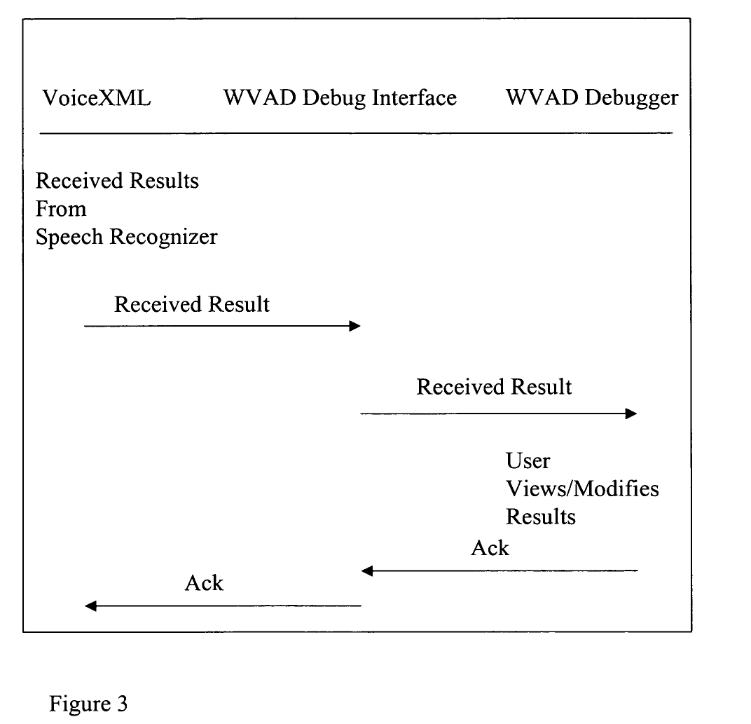

A Received Result occurs when a Speech Recognition result is sent to the VoiceXML interpreter (20). Accordingly, further, with reference to FIG. 2 and FIG. 3 (which illustrates a WVAD message processing for a Received Result) the WVAD Debug Interface (40) blocks the VoiceXML interpreter (20) and forwards this event to the WVAD debugger (50). A WVAD debugger (50) then notifies the user that a Received Result event occurred. At this point, the user has the ability to view and/or modify this result. After the user views and/or modifies the result, an acknowledgement (“Ack” in FIG. 3), which includes updated data, is sent from the WVAD debugger to the WVAD Debug Interface. When the WVAD Debug Interface receives this acknowledgement, the block is removed from the VoiceXML interpreter and the application continues to run normally.

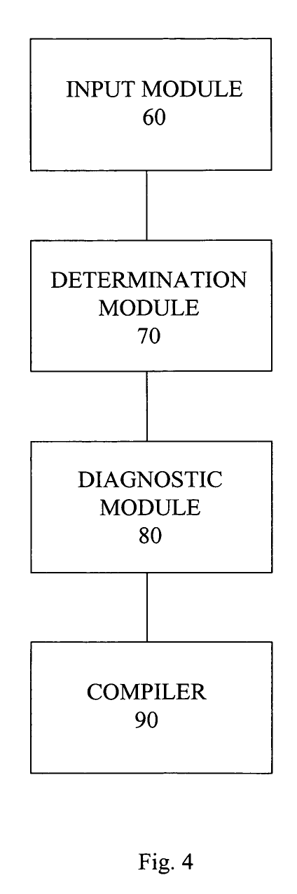

FIG. 4 illustrates a block diagram of an exemplary system for operating one or more applications for a speech recognition system and/or tool according to some embodiment of the present invention. As shown,, an input module (60) receives spoken input and may comprise, for example, a microphone and/or analog/digital converter for converting the analog audio signal into digital data. The system may also include a determination module (70) for determining a recognition result, where the recognition result may include one or more attributes. Further still, the system may include either or both of a diagnostic module (80) and a compiler (90). The diagnostic module is in communication with the determination module and may be sued to alter at least one of the attributes. The compiler may be used to run the one or more applications with the altered attributes.

It is worth noting that one or ordinary skill in the art that other embodiments of the invention may include computer systems to operate the methods and/or application according to the invention.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

What is claimed is:

1. A method of altering a speech recognition result in an application that uses speech recognition and using the altered result in the application, the method comprising:
receiving a spoken input;
determining a recognition result wherein the recognition result includes a plurality of attributes;
altering an attribute; and
running the application with the altered attribute.

2. A method according to claim 1, wherein one of the attributes is a speech utterance result.

3. A method according to claim 1, wherein one of the attributes is a confidence level.

4. A method according to claim 1, wherein one of the attributes is a N-best list.

5. A method according to claim 1, wherein one of the attributes is an interpretation.

6. A method according to claim 1, wherein immediately subsequent to a result being determined said application stops execution.

7. A method according to claim 6 further comprising displaying a listing of at least one of the plurality of attributes on a monitor.

8. A method according to claim 1 further comprising saving the altered attribute.

9. A method of altering a speech recognition result in an application that uses speech recognition and using the altered result in the application, the method comprising:
receiving a spoken input;
determining a recognition result wherein the recognition result includes a plurality of attributes;
altering a plurality of the attributes; and
running the application with the plurality of altered attributes.

10. A method according to claim 9, wherein at least one of the attributes is a speech utterance result.

11. A method according to claim 9, wherein at least one of the attributes is a Confidence level.

12. A method according to claim 9, wherein at least one of the attributes is a N-best list.

13. A method according to claim 9, wherein at least one of the attributes is an interpretation.

14. A method according to claim 9, wherein immediately subsequent to a result being determined said application stops execution.

15. A method according to claim 14 further comprising displaying a listing of at least one of the plurality of attributes on a monitor.

16. A method according to claim 9 further comprising saving the altered attributes.

17. A speech recognition diagnostic tool to alter a speech recognition result in an application that uses speech recognition and uses the altered result in the application comprising:
input means for receiving a spoken input;
determination means in communication with the input means for determining a recognition result wherein the recognition result includes a plurality of attributes;
diagnostic means in communication with the determination means for altering at least one of the plurality of the attributes; and
compiling means for running the application with the altered attribute.

18. A diagnostic tool according to claim 17, wherein at least one of the attributes is a speech utterance result.

19. A diagnostic tool according to claim 17, wherein at least one of the attributes is a confidence level.

20. A diagnostic tool according to claim 17, wherein at least one of the attributes is a N-best list.

21. A diagnostic tool according to claim 17, wherein at least one of the attributes is an interpretation.

22. A diagnostic tool according to claim 17 further comprising a means to stop application execution.

23. A diagnostic tool according to claim 22 further comprising a means of displaying a listing of at least one of the plurality of attributes on a monitor.

24. A diagnostic tool according to claim 17 further comprising a means of saving the altered attribute.

25. A speech recognition diagnostic tool to alter a speech recognition result in an application that uses speech recognition and uses the altered result in the application comprising:
an input module for receiving a spoken input;
a determination module in communication with the input means for determining a recognition result wherein the recognition result includes a plurality of attributes;
a diagnostic module in communication with the determination means for altering at least one of the plurality of the attributes; and
a compiler for running the application with the altered attribute.

26. A diagnostic tool according to claim 17, wherein at least one of the attributes is a speech utterance result.

27. A diagnostic tool according to claim 17, wherein at least one of the attributes is a confidence level.

28. A diagnostic tool according to claim 17, wherein at least one of the attributes is a N-best list.

29. A diagnostic tool according to claim 17, wherein at least one of the attributes is an interpretation.
